(19) United States
(12) Patent Application Publication
(10) Pub. No.: US 2012/0222129 A1
(43) Pub. Date: Aug. 30, 2012

(54) SYSTEM AND METHOD FOR SECURE MOBILE APPLICATION DOWNLOAD

(75) Inventors: Gustavo Racciopi, Lausanne (CH); Alain Pulluelo, Neuchatel (CH); Laurent Filliat, Geneve (CH)

(73) Assignee: CIDWAY TECHNOLOGIES, LTD., London (GB)

(21) Appl. No.: 13/034,427

(22) Filed: Feb. 24, 2011

(51) Int. Cl. G06F 15/16; G06F 21/00

(52) U.S. Cl. 726/27; 709/217; 709/206

(57) ABSTRACT

Methods and systems for downloading applications to a mobile communicator and for protecting access to stored mobile applications are disclosed.

### FIELD OF THE INVENTION

The present invention relates generally to methods and systems for downloading applications to a mobile communicator and for protecting access to stored mobile applications including application stores.

### BACKGROUND OF THE INVENTION

Users of mobile communication devices such as a smart phone may download applications from an application download site or from an application store. Unfortunately, hackers may deceive the user into downloading a tampered application instead of the genuine application; thereby, the hacker may retrieve all types of confidential information from the user such as usernames, passwords, and account numbers, and the like, without the user's authorization. This is a problem for service providers willing to deploy mobile applications to their customers, and it is a problem for the users of those applications as well. Thus, a need exists for a system and method for the secure download of applications to a mobile communication device and for protecting access to stored mobile applications, including application stores.

### SUMMARY OF THE INVENTION

In accordance with various aspects of the present invention, a method and system for protecting the download and the registration of genuine application data in a mobile communication device is disclosed. In an exemplary embodiment, to accomplish the secure deployment of a mobile application, the user receives a trusted application download link. By following this link, the genuine application can be downloaded and triggers the lifespan of an activation code. Using this activation code, the application can proceed to the provisioning process during which the application becomes operational.

### BRIEF DESCRIPTION OF THE DRAWINGS

A more complete understanding of the present invention may be derived by referring to the detailed description and claims when considered in connection with the Figures, where like reference numbers refer to similar elements throughout the Figures, and:

FIG. 1 illustrates a flow chart of the mobile application secure download and registration according to an embodiment of the present invention;

FIG. 2 illustrates a flow chart of the set up and use of a secure mobile application download in the exemplary context of a user requesting a mobile application using a computer and using the communication capabilities of his mobile device to download the application and register it;

FIG. 3 illustrates a flow chart of the set up and use of a secure mobile application download in the exemplary context of a user requesting a mobile application using a computer and using the communication capabilities of his mobile device to download the application from an application store using a download redirection feature; and

FIG. 4 illustrates a flow chart of the set up and use of a secure mobile application download in the exemplary context of a user requesting a mobile application using a computer, receiving the application on the computer, installing the application on the mobile device, and registering the application without using the communication capabilities of the mobile device.

### DETAILED DESCRIPTION OF PREFERRED EMBODIMENTS

The present invention may be described herein in terms of various functional components and various processing steps. It should be appreciated that such functional components may be realized by any number of hardware or structural components configured to perform the specified functions. For example, the present invention may employ various integrated components, such as transistors, amplifiers, buffers, and logic devices comprised of various electrical devices, e.g., resistors, capacitors, diodes and the like, whose values may be suitably configured for various intended purposes. In addition, the present invention may be practiced in any number of mobile devices and/or various embodiments of software applications.

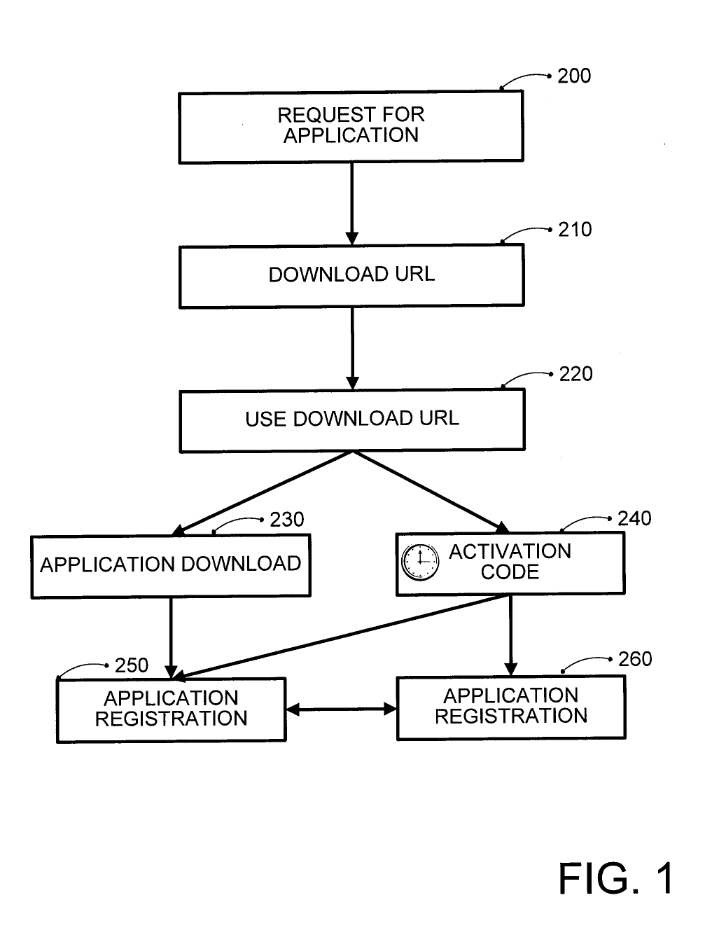

In accordance with an exemplary embodiment and with reference to FIG. 1, a flow chart of the secure download and registration of a mobile application is illustrated. In accordance with an aspect of this embodiment, an activation code is used to register the mobile application, but the lifespan of the activation code is not started until the user downloads the application from the relevant download universal resource locator (URL) that is provided to the user. It should be appreciated that this will reduce the risk of the user downloading a tampered application.

As illustrated in FIG. 1, a request for providing the mobile application is issued (200), usually by the service provider. An application download URL is provided to the user (210). The user follows this given download URL (220) to download the application (230). When the application is downloaded from the given download URL (220), the lifespan start of an activation code is triggered (240). The activation code is used by the application to start the registration process (250) against the registration server (260), and thus to provide the necessary data for the application to operate. In accordance with an aspect of this embodiment, the activation code is valid for a limited period of time following the application download by the user.

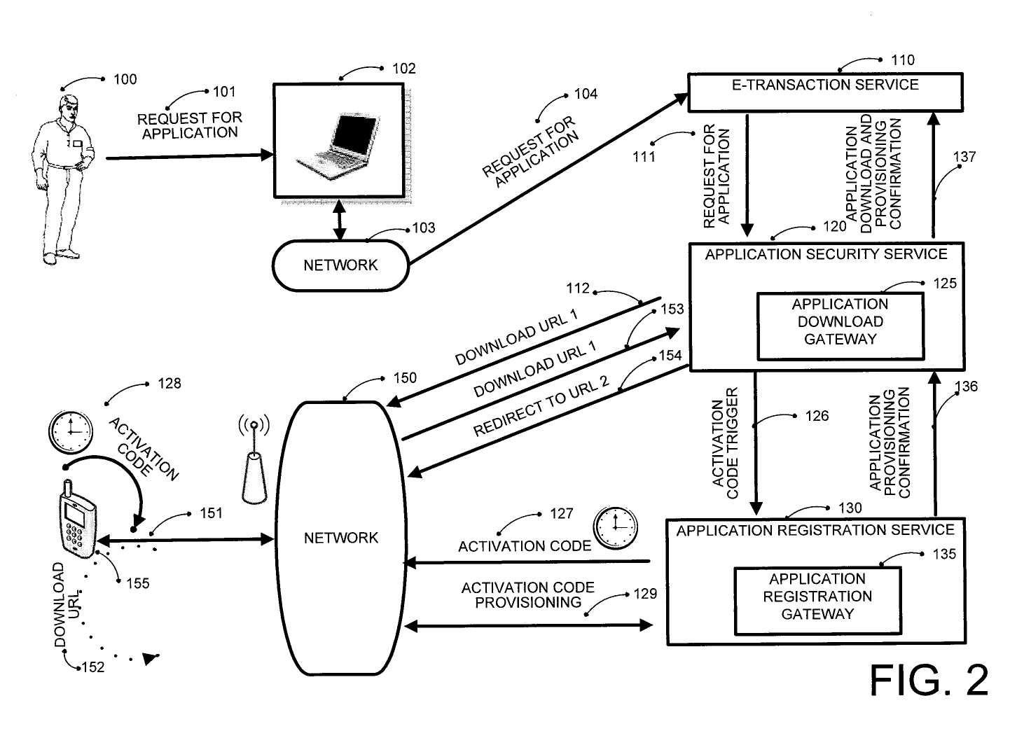

In an exemplary embodiment and with reference to FIG. 2, the set up and use of a secure mobile application download in the exemplary context of a user requesting a mobile application using a computer and using the communication capabilities of a mobile device to download and register the application will be described next. In accordance with an aspect of this embodiment, the mobile application registration is authorized with the activation code only if the application is downloaded from the dedicated download gateway, preventing the risk of having the user download a tampered application.

As illustrated in FIG. 2, user 100 requests a mobile application (101) from an E-transaction service provider 110, using a personal computer (PC) 102 that is connected to network 103.

The request for application (101) may be performed using any suitable communications link such as voice, hard copy letter, e-mail, short message service (SMS), personal computer, smart phone, or the like.

It will be appreciated that the term “request for application” includes any data received by the E-transaction service provider 110, which enables the user to request the mobile application. The E-transaction service may be a bank or any other service provider that provides remote services to its customers.

In accordance with an exemplary embodiment, when the user makes a request for application (101), the user provides information that typically includes identification information and personal information or credential such as a username or an account number. The instance of the mobile application will be associated with the user's account.

In accordance with an exemplary embodiment, after receiving and accepting the request for application (104), the E-transaction service 110 sends a request for application (111) to an application security service 120. Application security service 120 is the entity that is in charge of managing the mobile application deployment. The application security service 120 may be an independent service provider or it may be hosted by the E-transaction service 110.

With continued reference to FIG. 2, following the reception of a request for application (111) for a dedicated user 100, the application security service 120 provides the user's mobile communication device 155 with an application download URL 112 through a wireless communication network 150. Mobile communication device 155 may be any mobile device capable of communication such as a smart phone, cell phone, music player (e.g., Apple i-Touch device), portable computer (e.g., Apple i-Pad device), and the like. The download URL 112 should be unique for each user and valid for a given period of time in order to trace the action of the user that should follow this URL. In various embodiments, this may be accomplished by adding a username or a user code or other extension to the URL. In accordance with this exemplary embodiment, the application download URL 112 is provided by SMS. However, in various embodiments, the application download URL 112 could be provided to the user by mail, e-mail, voice, and the like, and then the user could enter this URL in the mobile browser 155.

The user 100 follows the received URL (152) with the browser of the mobile device 155, and thus gains access to the application download gateway 125. The application download gateway 125 provides the mobile device 155 with the mobile application 154. In accordance with this exemplary embodiment, the application download gateway 125 detects the type and model of mobile device 155 and provides the relevant application for the mobile device such as Java ME or J2ME, iPhone, Android, BlackBerry, Windows Mobile, and the like.

In accordance with this exemplary embodiment and with continued reference to FIG. 2, when the application download gateway 125 detects that the user has downloaded the mobile application using the download URL 152, the application security service sends an activation code trigger 126 to the application registration service 130. This will allow the application registration service 130 to start the lifespan of the activation code that will be used by the mobile application to run its provisioning. The application registration service 130 is an entity in charge of managing the mobile application registration. In accordance with various embodiments, the application registration service 130 can be part of the application security service 120.

It will be appreciated that in accordance with this exemplary embodiment, the activation code may be sent using an out-of-band method such as SMS, email or mail. In accordance with an aspect of the present invention, the validity of activation code 127 depends on having the user download the mobile application 154 from the application download gateway 125 and not from somewhere else. In accordance with this exemplary embodiment, the activation code has a limited lifespan.

In accordance with this exemplary embodiment, the activation code 128 is entered in the mobile application to start the process of provisioning against the application registration gateway 135. The mobile application sends the activation code 129 to the application registration gateway 135. During the provisioning process, the mobile device is registered and cryptographic keys are managed between the mobile application and the application registration gateway 135. In accordance with various embodiments, by way of example, the cryptographic keys could include symmetric keys to generate authentication codes, to encrypt or sign data. Alternatively, the cryptographic keys could include asymmetric keys for encryption or signature.

The application registration service 130 may be an independent service provider or it may be hosted by the E-transaction service 110 or by the application security service 120.

In accordance with this exemplary embodiment, the application registration service sends an application provisioning confirmation 136 to the application security service 120, providing proof that the user's mobile application has been successfully registered. The application security service 120 sends an application download and provisioning confirmation 137 to the E-transaction service 110 to end the process.

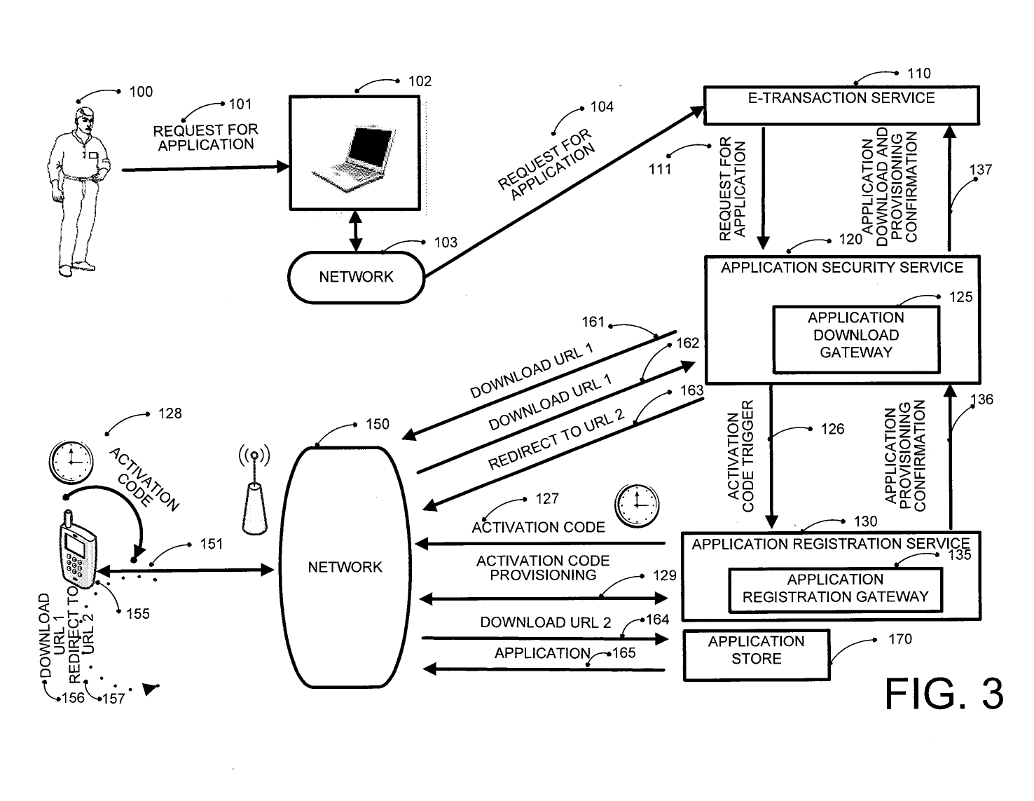

With reference to FIG. 3, another exemplary embodiment of the present invention is illustrated. The principle of download and provisioning of the mobile application remains similar to the embodiment illustrated in FIG. 2. In accordance with this exemplary embodiment, the application download gateway redirects the user's mobile browser to another application store in order to download the application.

With continued reference to FIG. 3, when the application security service 125 receives the request for application 111 from the E-transaction service 110, the application security service 125 provides the user with a first download URL 161. Then, the user follows the first download URL (step 162). The application download gateway 125 may determine the type of mobile device 155. If the mobile application must be downloaded from another mobile application store 170, the application download gateway 125 redirects the mobile's browser to a second URL 163 using, for example, the following method:

The download gateway answers by an HTTP return code (163) (URL moved permanently—see HTTP Code Status, RFC 2616) containing the redirect URL

1. The mobile browser receives and interprets the HTTP redirect (163) and fetches the redirect URL.

2. The mobile browser fetches the second URL (164) and downloads the application 165 from an application store 170. For example, this technique of redirect URL may be used for an AppStore application.

It will be appreciated that this exemplary embodiment of the present invention has the same goals: the registration of the mobile application is authorized with the activation code only if the application is downloaded from the dedicated download gateway (after being redirected by the application download gateway), preventing the risk of having the user download a tampered application.

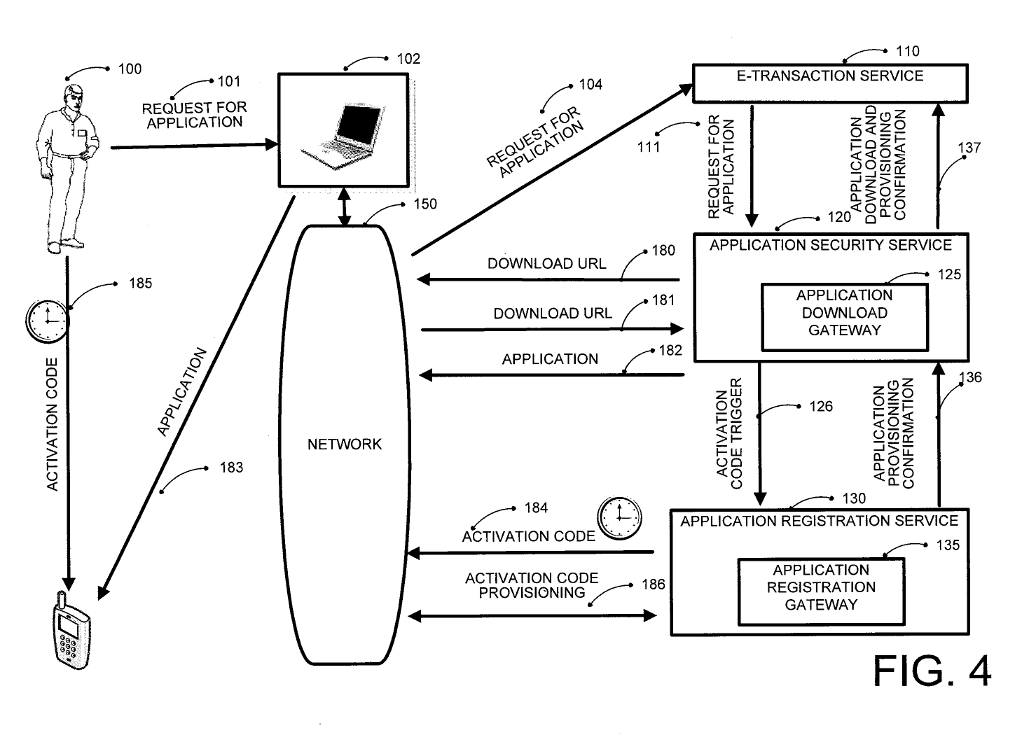

With reference to FIG. 4, another exemplary embodiment of the present invention is illustrated. In accordance with this exemplary embodiment, the downloading and provisioning of the mobile application is accomplished via the user's PC 102, and the mobile communication capability is not used.

With continued reference to FIG. 4, the user browses with the PC to the application security service 120 web site. Using the PC, the user accesses the download URL 180 link, follows it (181) and downloads the mobile application 182 to the PC. Then, the user transfers the application 183 to the mobile device 155 using a suitable connection such as a cable, Bluetooth, copying the application to a memory card, or using any other suitable communication.

In accordance with this exemplary embodiment, the application security service 120 sends an activation code trigger to the application registration service 130. This will start the lifespan of the activation code 184 that will be displayed to the user's PC that is to be entered in the mobile application to start the provisioning process. It is appreciated that in accordance with the present invention, the activation code may be eventually sent using an out-of-band method such as SMS, email or mail. In accordance with this exemplary embodiment, some data may be exchanged between the mobile application and the application registration gateway 135, but always through the user's PC 102. For example, the mobile device displays a string that the user enters on the application registration gateway 135 and then the user keys on the mobile keypad, the data displayed on the PC by the application registration gateway 135, until the completion of the application provisioning 186.

This exemplary embodiment, illustrated in FIG. 4, may be used for the situation where the mobile device does not have communication capabilities, or if, for any reasons, the provisioning must be done ‘manually’.

It will be appreciated by persons skilled in the art that the present invention is not limited to what has been particularly shown and described hereinabove. Rather the scope of the present invention includes both combinations and subcombinations of various features described hereinabove as well as modifications of such features which would occur to a person of ordinary skill in the art upon reading the foregoing description and which are not in the prior art.

Benefits, other advantages, and solutions to problems have been described herein with regard to specific embodiments. However, the benefits, advantages, solutions to problems, and any elements that may cause any benefit, advantage, or solution to occur or become more pronounced are not to be construed as critical, required, or essential features or elements of the inventions. The scope of the inventions is accordingly to be limited by nothing other than the appended claims, in which reference to an element in the singular is not intended to mean “one and only one” unless explicitly so stated, but rather “one or more.” Moreover, where a phrase similar to “at least one of A, B, or C” is used in the claims or specification, it is intended that the phrase be interpreted to mean that A alone may be present in an embodiment, B alone may be present in an embodiment, C alone may be present in an embodiment, or that any combination of the elements A, B and C may be present in a single embodiment; for example, A and B, A and C, B and C, or A and B and C. Furthermore, no element, component, or method step in the present disclosure is intended to be dedicated to the public regardless of whether the element, component, or method step is explicitly recited in the claims. No claim element herein is to be construed under the provisions of 35 U.S.C. 112, sixth paragraph, unless the element is expressly recited using the phrase “means for.” As used herein, the terms “comprises”, “comprising”, or any other variation thereof, are intended to cover a non-exclusive inclusion, such that a process, method, article, or apparatus that comprises a list of elements does not include only those elements but may include other elements not expressly listed or inherent to such process, method, article, or apparatus.

What is claimed is:

1. A computer-implemented method of providing an application to a mobile device, the method comprising the steps of:
configuring an application download link to download the application when activated;
providing a user with the application download link;
detecting when the application download link is activated;
starting an activation code lifespan by a server;
providing the user with a relevant lifespan limited activation code;
receiving the activation code; and
initiating a provisioning process for the application.

2. The computer-implemented method of claim 1, further comprising the steps of:
providing a first application download link that can differ from a first user to a second user; and
tracing the first user when the first user uses the first application link to download the application.

3. The computer-implemented method of claim 1, further comprising the steps of:
providing the user with a first application download link;
detecting when the first application download link is activated; and
redirecting the user's mobile device to a second download link to download the application.

4. The computer-implemented method of claim 1, further comprising the step of providing the application download link to the user by one of short message service (SMS), e-mail, phone call, mobile voice, or other data transmission.

5. The computer-implemented method of claim 1, further comprising the step of providing the application download link to a user's computer by one of e-mail, voice, or other data transmission.

6. The computer-implemented method of claim 1, further comprising the step of providing the application download link by one of mail, fax, paper or other non-computer data transmission.

7. The computer-implemented method of claim 1, further comprising the step of providing the activation code to the mobile device by one of SMS, e-mail, phone call, mobile voice, or other data transmission.

8. The computer-implemented method of claim 1, further comprising the step of providing the activation code to a user's computer by one of e-mail, voice, or other computer data transmission.

9. The computer-implemented method of claim 1, further comprising the step of providing the activation code by mail, fax, paper, or other non-computer data transmission.

10. The computer-implemented method of claim 1, wherein the application provisioning is performed using mobile communication capabilities such as SMS, hypertext transfer protocol (HTTP), wireless application protocol (WAP), WIFI or any other mobile device communication capability.

11. The computer-implemented method of claim 1, wherein the application provisioning is performed without using mobile communication capabilities, and wherein the application provisioning is performed using a mobile display, a keyboard or a physical communication link such as Infra Red, universal serial bus (USB), craddle or any other mobile physical connection.

12. The computer-implemented method of claim 1, wherein the application provisioning comprises providing the application with access to authentication secrets.

13. The computer-implemented method of claim 1, wherein the application provisioning comprises providing the application with access to digital signature secrets.

14. The computer-implemented method of claim 1, wherein the application provisioning comprises providing the application with access to a public key infrastructure (PKI) key.
